(19) United States
(12) Patent Application Publication
(10) Pub. No.: US 2010/0117485 A1
(43) Pub. Date: May 13, 2010

(54) PIEZOELECTRIC TRANSDUCERS WITH NOISE-CANCELLING ELECTRODES

(75) Inventors: Steven Martin, Fort Collins, CO (US); Osvaldo Buccafusca, Fort Collins, CO (US)

Correspondence Address: Kathy Manke;Avago Technologies Limited, 4380 Ziegler Road, Fort Collins, CO, 80525, US

(73) Assignee: Avago Technologies Wireless IP (Singapore) Pte. Ltd., Singapore (SG)

(21) Appl. No.: 12/270,251

(22) Filed: Nov. 13, 2008

(51) Int. Cl. H02N 2/18

(52) U.S. Cl. 310/319

(57) ABSTRACT

In a representative embodiment, an apparatus comprises a transducer providing a first output; a capacitor providing a second output; a first load impedance connected to the first output; a second load impedance connected to the second output; and a differential amplifier having a first input connected to the first output and a second input connected to the second output. Illustratively, the first load impedance is connected electrically in parallel with the first input and the second load impedance is connected electrically in parallel with the second input.

### CROSS-REFERENCE TO RELATED APPLICATIONS

The present application is related to commonly owned U.S. patent applications: MULTI-LAYER TRANSDUCERS WITH ANNULAR CONTACTS Ser. No. 11/11/604,478, to R. Shane Fazzio, et al. entitled TRANSDUCERS WITH ANNULAR CONTACTS and filed on Nov. 27, 2006; and Ser. No. 11/737,725 to R. Shane Fazzio, et al. entitled MULTI-LAYER TRANSDUCERS WITH ANNULAR CONTACTS and filed on Apr. 19, 2007. The entire disclosures of these related applications are specifically incorporated herein by reference.

### BACKGROUND

Transducers are used in a wide variety of electronic applications. One type of transducer is known as a piezoelectric transducer. A piezoelectric transducer comprises a piezoelectric material disposed between electrodes. The application of a time-varying electrical signal will cause a mechanical vibration across the transducer; and the application of a time-varying mechanical signal will cause a time-varying electrical signal to be generated by the piezoelectric material of the transducer. One type of piezoelectric transducer may be based on film bulk acoustic resonators (FBARs) and bulk acoustic resonators (BAWs). As is known, disposed FBARs and certain BAW devices over a cavity in a substrate, or otherwise suspending at least a portion of the device will cause the device to flex in a time varying manner. Such resonators are often referred to as membranes.

As should be appreciated, among other applications, piezoelectric transducers may be used to transmit or receive mechanical and electrical signals. These signals may be the transduction of acoustic signals, for example, and the transducers may be functioning as microphones (mics) and speakers. As the need to reduce the size of many components continues, the demand for reduced-size transducers continues to increase as well. This has lead to comparatively small transducers, which may be micromachined according to technologies such as micro-electromechanical systems (MEMS) technology, such as described in the related applications.

While small feature size transducers do show promise, there are certain drawbacks to known devices that deleteriously impact their performance and thus their attractiveness for commercial implementation. One such drawback is their propensity to provide an unacceptably low signal-to-noise ration (SNR). FIG. 1 shows an equivalent circuit of a transducer 101 (shown as an equivalent voltage source (V_{piezo}) and an equivalent capacitance C_{piezo}) connected to an amplifier 102. As is known, small feature-size transducers comprise a comparatively small intrinsic capacitance (C_{piezo}) and provide a comparatively small piezoelectric effect. These factors tend to limit the signal amplitude due to the voltage divider circuit formed by Cpiezo and RL. Moreover, the comparatively large electrode area, makes the sensor susceptible to ambient noise (e.g., background electromagnetic signals). Finally, the transducer 101 has a comparatively large source impedance that when coupled with the required large load resistance (R_{L}) 103, can result in the ambient noise's dominating the signal. Notably, as shown in FIG. 1, at 104 the ambient electromagnetic noise from the transducer 101 ‘sees’ a comparatively high impedance load resistance 103 which can result in significant voltage noise at the amplifier's input terminal. Thus, the comparatively low signal amplitude of the desired signal from the transducer 101 is dominated by the ambient noise, a problem further exacerbated by electronic noise in the amplification circuit.

What is needed, therefore, is an apparatus that overcomes at least the drawbacks of known transducers discussed above.

### SUMMARY

In accordance with a representative embodiment, an apparatus, comprises a transducer providing a first output; a capacitor providing a second output; a first load impedance connected to the first output; a second load impedance connected to the second output; and a differential amplifier having a first input connected to the first output and a second input connected to the second output. Illustratively, the first load impedance is connected electrically in parallel with the first input and the second load impedance is connected electrically in parallel with the second input.

In accordance with another representative embodiment, an apparatus configured to transmit acoustic signals or receive acoustic signals, or both, comprising: a membrane comprising a film bulk acoustic (FBA) transducer providing a first output; a capacitor device providing a second output; a first load impedance connected to the first output; a second load impedance connected to the second output; and a differential amplifier having a first input connected to the first output and a second input connected to the second output. Illustratively, the first load impedance is connected electrically in parallel with the first input and the second load impedance is connected electrically in parallel with the second input.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 shows a simplified schematic diagram of an equivalent circuit of a known transducer circuit.

FIG. 2A shows a simplified schematic diagram of an equivalent circuit of a transducer circuit in accordance with a representative embodiment.

FIG. 2B shows a simplified schematic diagram of an equivalent circuit of a transducer circuit in accordance with a representative embodiment.

FIG. 3A shows a top view of a transducer and a capacitor on a common substrate in accordance with a representative embodiment.

FIG. 3B shows a cross-sectional view of the transducer and capacitor shown in FIG. 3A.

FIG. 3C shows a top view of a transducer and a capacitor on a common substrate in accordance with a representative embodiment.

FIG. 3D shows a cross-sectional view of the transducer and capacitor shown in FIG. 3C.

FIG. 3E shows a top view of a transducer and a capacitor on a common substrate in accordance with a representative embodiment.

FIG. 3F shows a cross-sectional view of the transducer and capacitor shown in FIG. 3A.

FIG. 4A shows a top view of a transducer and a capacitor on a common substrate in accordance with a representative embodiment.

FIG. 4B shows a cross-sectional view of the transducer and capacitor shown in FIG. 4A.

### DEFINED TERMINOLOGY

As used herein, the terms ‘a’ or ‘an’, as used herein are defined as one or more than one.

In addition to their ordinary meanings, the terms ‘substantial’ or ‘substantially’ mean to with acceptable limits or degree to one having ordinary skill in the art. For example, ‘substantially cancelled’ means that one skilled in the art would consider the cancellation to be acceptable.

In addition to their ordinary meanings, the terms ‘approximately’ mean to within an acceptable limit or amount to one having ordinary skill in the art. For example, ‘approximately the same’ means that one of ordinary skill in the art would consider the items being compared to be the same.

### DETAILED DESCRIPTION

In the following detailed description, for purposes of explanation and not limitation, representative embodiments disclosing specific details are set forth in order to provide a thorough understanding of the present teachings. Descriptions of known devices, materials and manufacturing methods may be omitted so as to avoid obscuring the description of the representative embodiments. Nonetheless, such devices, materials and methods that are within the purview of one of ordinary skill in the art may be used in accordance with the representative embodiments.

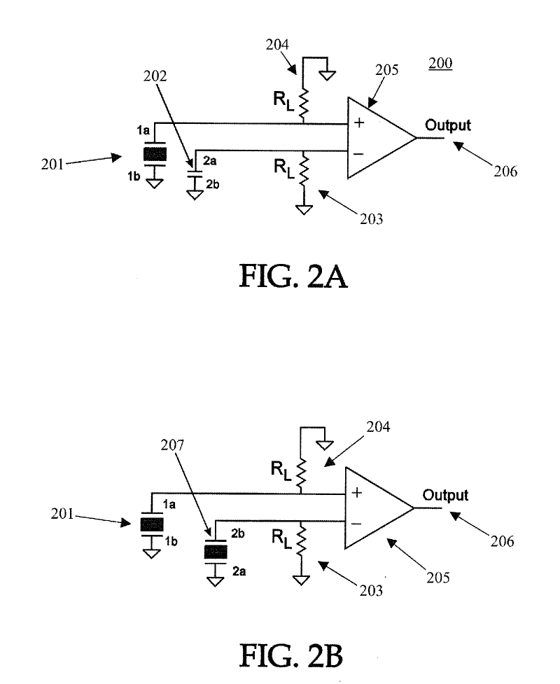

FIG. 2A shows a simplified schematic diagram of an equivalent circuit 200 of a transducer circuit in accordance with a representative embodiment. The circuit comprises a transducer 201, which is illustratively a piezoelectric transducer based on film bulk acoustic (FBA) transducer technology or bulk acoustic wave (BAW) technology. Additional details of the transducer 201 are described in the referenced applications to Fazzio, et al. and below. Notably, the transducer 201 is a membrane device operative to oscillate by flexing over a substantial portion of the active area thereof. Moreover, the use of micromachined ultrasonic transducers (MUTs) and piezoelectric MUTs are also contemplated for use in the transducer of representative embodiments. These types of transducers are known to those of ordinary skill in the art.

The circuit 200 also comprises a capacitor device 202, which in the present embodiment is not subject to the piezoelectric effect. As described below, the capacitor device is configured to provide an electromagnetic noise signal for cancellation of a noise signal garnered by the transducer 201.

The circuit 200 includes a load resistance 203 connected to a first electrode 2a of the capacitor device 202 and a load resistance 204 connected to a first electrode 1a of the transducer 201. As shown, in this configuration, the capacitor comprises a second electrode 2b connected to ground and the transducer 201 comprises a second electrode also connected to ground. First contacts 1a and 2a of the transducer 201 and the capacitor 202 provide a first output and a second output, respectively, which are also connected to a first (illustratively positive) input and a second (illustratively negative) input of a differential amplifier 205 of circuit 200. Notably, second contacts 1b, 2b of the transducer 201 and the capacitor 202, respectively are connected to ground.

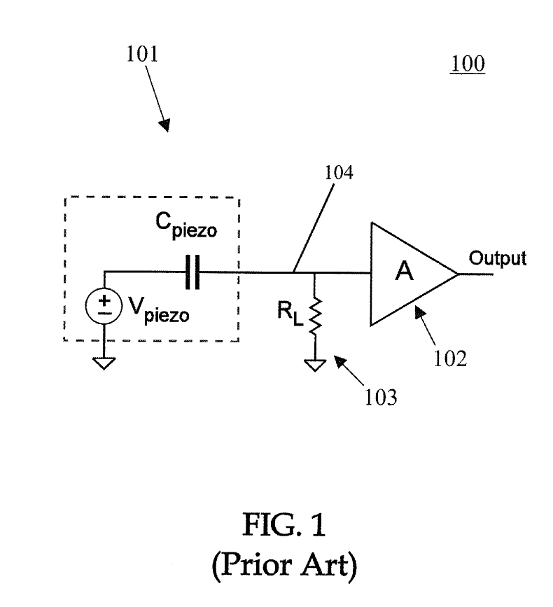

In operation, an incident signal on the transducer is converted from a mechanical wave to an electrical wave and emerges from the first output as a signal. This signal is provided to the positive input 205 and to the load resistance 204. However, because of the parallel electrical connection shown, the signal ‘sees’ a comparatively high impedance value at the resistance 204, and the voltage at the positive input of the differential amplifier 205 is reduced by the voltage divider circuit comprised of the transducer's output impedance and the resistance 204. Unfortunately, noise can also be incident on the transducer 201 and the electrical wiring connecting the transducer to the resistance 204 and amplifier 205. As described in connection with FIG. 1, the magnitude of the (desired) signal from the transducer can be small compared to the noise signal, and after amplification, can be lost in the noise. In accordance with a representative embodiment, beneficially the noise is substantially cancelled. In particular, the first contact 1b of the capacitor 202 provides an output that is connected to the second (in this example negative) input of the differential amplifier 205. The noise signal is incident on the capacitor 202 and the electrical connections interconnecting the capacitor to the resistance 203 and amplifier 205 in a like manner as on the transducer and other electrical node, and thus is transmitted to the amplifier 205. However, because the noise signal is provided to the negative input of the differential amplifier, its magnitude is substantially the same after amplification but its phase is opposite (i.e., everywhere π-radians out of phase) to the noise signal from the transducer 201. Thus, the noise signal cancels and an output 206 from the amplifier is substantially the amplified (desired) transducer signal.

FIG. 2B shows a simplified schematic diagram of an equivalent circuit of a transducer circuit in accordance with a representative embodiment. The equivalent circuit of FIG. 2B shares many common features with the circuit of FIG. 2A, which are not repeated in order to avoid obscuring the details of the present representative embodiments.

As can be appreciated from a review of the embodiment of FIG. 2B, instead of a capacitor 202, the second differential input (in this case the negative input) of the presently described embodiment is connected to a second transducer 207. The second transducer 207 is substantially identical to the first transducer 201, however, is connected in an opposite manner to the second input of the differential amplifier 205. The reversal of the connections to effect the desired phase may be effect as described in the referenced applications to Fazzio, et al. Thus, the phase of the (desired) signal at the output of the transducer (i.e., at contact 2b) is of substantially the same magnitude but opposite phase as the (desired) signal at the output (i.e., at contact 1 a) of the first transducer 201. By contrast, because the noise signal is garnered by capacitive coupling at the transducers 201, 202, the amplitude and phase of the noise signals provided at the respective outputs 1a and 2b are substantially the same. Thus, outputs 1a and 2b provide (desired) signals of substantially opposite phase and substantially in-phase noise signals to the first and second (differential) inputs of amplifier 205. After amplification and combination, the output 206 of the amplifier 205 comprises an amplification of the sum of the (desired) signals from the transducers 201, 207. In the illustrative embodiment, the amplitude of the output 206 is approximately twice that of the desired signals from the transducers 201, 207.

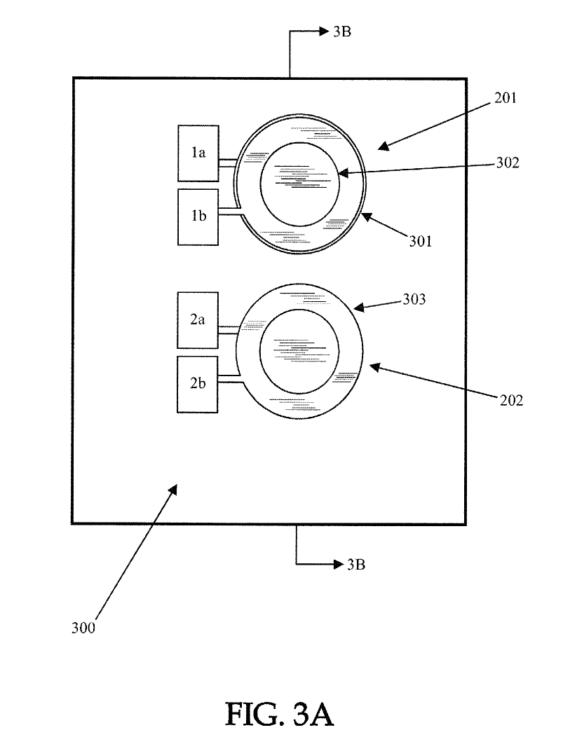

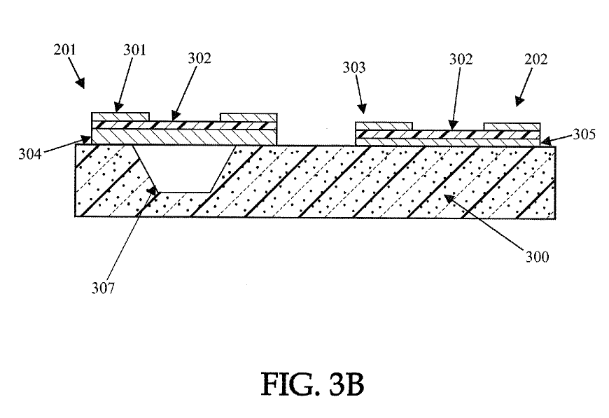

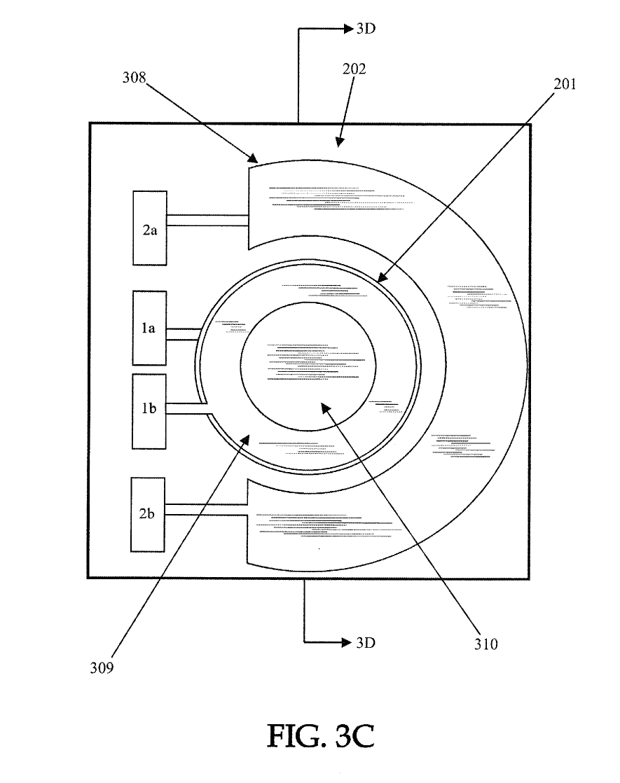

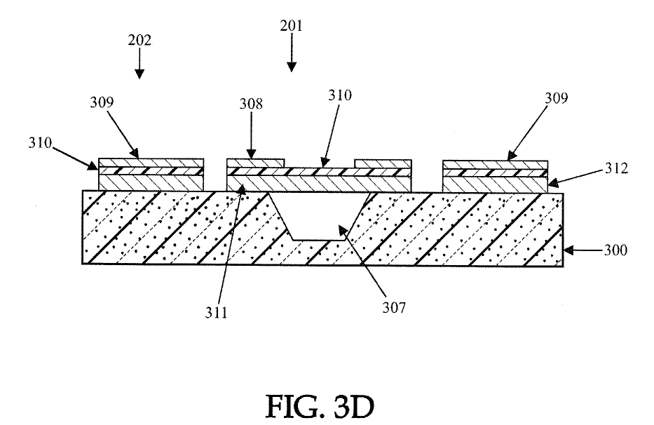

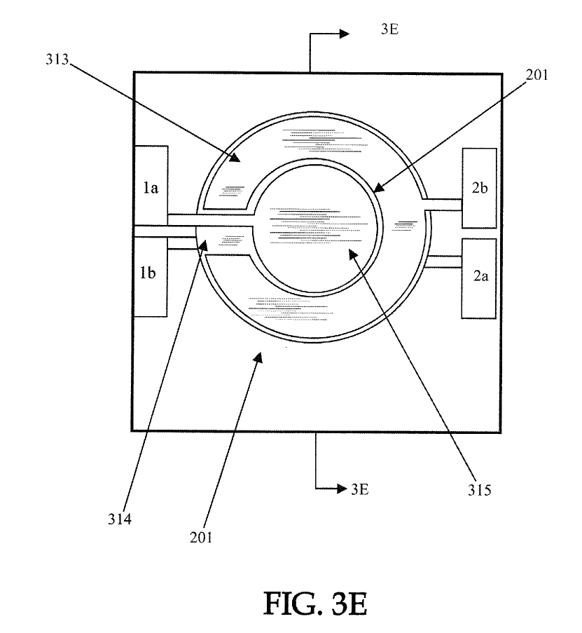

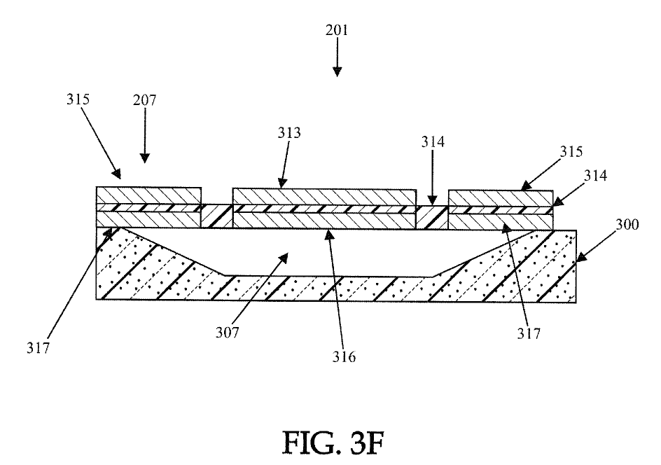

FIG. 3A shows a top view of transducer 201 and capacitor 202 on a common substrate 300 in accordance with a representative embodiment. The transducer 201 and capacitor may be fabricated using methods and materials in accordance with the teachings of the referenced applications to Fazzio, et al., or using other known methods and materials. Thus, fabrication sequences are omitted in order to avoid obscuring the descriptions of the representative embodiments.

The transducer comprises an upper electrode 301 and a piezoelectric layer 302 disposed over the substrate 300. The capacitor 202 comprises an upper electrode 303 disposed over the substrate 300. As shown, the electrodes 301, 303 are substantially circular and of approximately the same area. Contacts 1b and 2b are connected to the upper electrodes 301, 303 and contacts 1a and 2a are connected to lower electrodes (not shown in FIG. 3A). As should be appreciated, the arrangement of FIG. 3A provides the transducer 201 and capacitor 202 with connections as shown in FIG. 2A.

FIG. 3B shows a cross-sectional view of the transducer 201 and capacitor 202 shown in FIG. 3A. The transducer 201 also comprises a lower electrode 304, which spans a cavity 307 (commonly referred to as a ‘swimming pool’), that provides a membrane structure to the transducer 201. Thus, the transducer 201 may flex over the cavity in response to electromagnetic or mechanical signals incident thereon. The capacitor also comprises a lower electrode 305, which is illustratively of the same shape as the upper electrode 303. However, this is not essential, and an electrode similar to that of lower electrode 304 can be provided. The area of the capacitor is of course dictated by the area of overlap of the upper and lower electrodes 303, 305. Finally, the dielectric of the capacitor may be provided by piezoelectric layer 302 or by another suitable dielectric material. Usefully, the capacitance of the capacitor 202 and the transducer 201 are substantially the same so the noise signals delivered to the amplifier 205 are substantially the same.

FIG. 3C shows a top view of transducer 201 and capacitor 202 on a common substrate 300 in accordance with a representative embodiment. The transducer 201 and capacitor may be fabricated using methods and materials in accordance with the teachings of the referenced applications to Fazzio, et al., or using other known methods and materials. Thus, fabrication sequences are omitted in order to avoid obscuring the descriptions of the representative embodiments.

The transducer comprises an upper electrode 308 and a piezoelectric layer 310 disposed over the substrate 300. The capacitor 202 comprises an upper electrode 309 disposed over the substrate 300. As shown, the electrodes 308, 309 are substantially circular and substantially concentric over a portion of an arc length. Beneficially, the areas of the electrodes 308, 309 are approximately the same. Contacts 1b and 2b are connected to the upper electrodes 308, 310 and contacts 1a and 2a are connected to lower electrodes (not shown in FIG. 3A). As should be appreciated, the arrangement of FIG. 3C provides the transducer 201 and capacitor 202 with connections as shown in FIG. 2A.

FIG. 3D shows a cross-sectional view of the transducer 201 and capacitor 202 shown in FIG. 3C. The transducer 201 also comprises a lower electrode 311, which spans cavity 307 (commonly referred to as a ‘swimming pool’), that provides a membrane structure to the transducer 201. Thus, the transducer 201 may flex over the cavity 307 in response to electromagnetic or mechanical signals incident thereon. The capacitor 202 also comprises a lower electrode 312, which is illustratively of the same shape as the upper electrode 309. However, this is not essential, and an electrode similar to that of lower electrode 311 can be provided. The area of the capacitor 202 is of course dictated by the area of overlap of the upper and lower electrodes 309, 312. Finally, the dielectric of the capacitor may be provided by piezoelectric layer 310 or by another suitable dielectric material. Usefully, the capacitance of the capacitor 202 and the transducer 201 are substantially the same so the noise signals delivered to the amplifier 205 are substantially the same.

FIG. 3E shows a top view of transducer 201 and transducer 207 on a common substrate 300 in accordance with a representative embodiment. The transducers 201, 207 may be fabricated using methods and materials in accordance with the teachings of the referenced applications to Fazzio, et al., or using other known methods and materials. Thus, fabrication sequences are omitted in order to avoid obscuring the descriptions of the representative embodiments.

Transducer 201 comprises an upper electrode 315 and transducer 207 comprises an upper electrode 313. A piezoelectric layer 314, which is disposed between the upper electrodes 313, 315 and lower electrodes (not shown in FIG. 3E), is provided. As shown, the electrodes 313, 315 are substantially circular and substantially concentric over at least a portion of an arc length. Beneficially, the areas of the electrodes 313, 315 are approximately the same. Contacts 1a and 2b are connected to the upper electrodes 313, 315 and contacts 1b and 2a are connected to lower electrodes (not shown in FIG. 3E). As should be appreciated, the arrangement of FIG. 3E provides the transducers 201, 207 with connections as shown in FIG. 2B.

FIG. 3F shows a cross-sectional view of the transducers 201, 207 shown in FIG. 3E. The transducer 201 also comprises a lower electrode 316, which spans cavity 307 (commonly referred to as a ‘swimming pool’), that provides a membrane structure to the transducer 201. Thus, the transducer 201 may flex over the cavity 307 in response to electromagnetic or mechanical signals incident thereon. The transducer 207 also comprises a lower electrode 317, which is illustratively of the same shape as the upper electrode 315. Usefully, the capacitance of the transducer 201 and the transducer 207 are substantially the same so the noise signals delivered to the amplifier 205 are substantially the same.

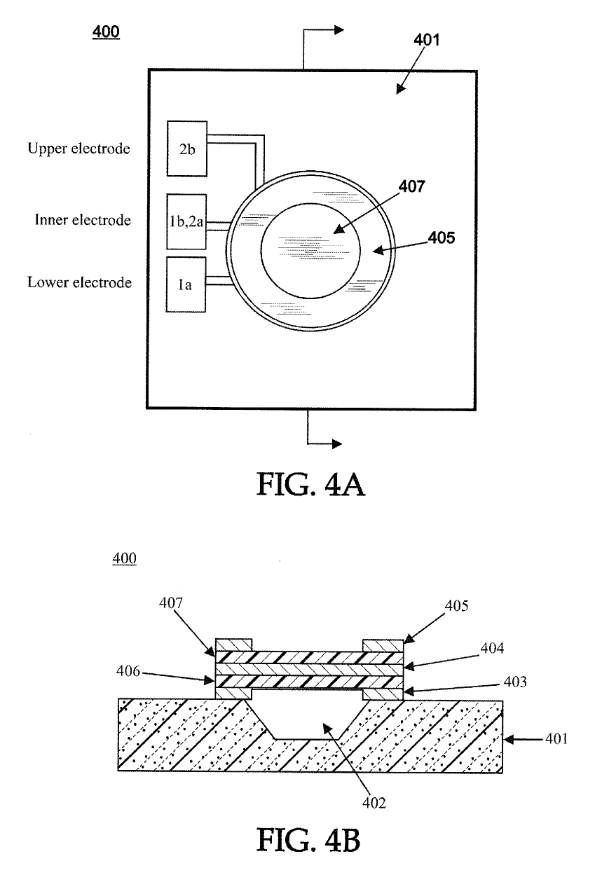

FIG. 4A is a top view of a transducer structure 400 comprising ‘vertical’ electrodes in accordance with a representative embodiment. FIG. 4A shows the transducer structure comprising a substrate 401, an upper electrode 405 and a second piezoelectric layer 405. FIG. 4B shows a cross-sectional view of the transducer structure 400 comprising ‘vertical’ electrodes shown in FIG. 4A. The transducer structure 400 may be fabricated using methods and materials in accordance with the teachings of the referenced applications to Fazzio, et al., or using other known methods and materials. Thus, fabrication sequences are omitted in order to avoid obscuring the descriptions of the representative embodiments.

The structure 400 comprises the substrate 401, which comprises a cavity 402 provided therein. A lower electrode 403 is provided over the cavity 402 and substrate as shown. A first piezoelectric layer 406 is provided over the lower electrode 403, and an inner electrode 404 is provided over the first piezoelectric layer 406. The second piezoelectric layer 407 is provided over the inner electrode 404, and the upper electrode 405 is provided over the second piezoelectric layer 407. The lower, inner and upper electrodes 403, 405, 405 are provided in a substantially annular arrangement relative to one another. In a representative embodiment, the inner electrode 404 can be connected as the common electrode (e.g., with a single contact for contacts 1b, 2a as shown) between one set of electrodes and the other set of electrodes. By appropriately connecting the outer electrodes to a readout circuit, the two sets of electrodes can be used in a differential configuration. For instance, if the neutral axis of the membrane stack is placed in the center electrode, the upper and common electrode would sense a piezoelectrically-developed voltage, and the common and bottom electrode would sense a piezoelectrically-developed voltage that is 180 degrees out of phase to the first voltage.

In view of this disclosure it is noted that the transducers and circuits useful for noise cancellation and amplification (gain) can be implemented in a variety of materials, variant structures, configurations and topologies. Moreover, applications other than small feature size transducers may benefit from the present teachings. Further, the various materials, structures and parameters are included by way of example only and not in any limiting sense. In view of this disclosure, those skilled in the art can implement the present teachings in determining their own applications and needed materials and equipment to implement these applications, while remaining within the scope of the appended claims.

1. An apparatus, comprising:
a transducer providing a first output;
a capacitor providing a second output;
a first load impedance connected to the first output;
a second load impedance connected to the second output; and
a differential amplifier having a first input connected to the first output and a second input connected to the second output, wherein the first load impedance is connected electrically in parallel with the first input and the second load impedance is connected electrically in parallel with the second input.

2. An apparatus as claimed in claim 1, wherein the transducer comprises a piezoelectric transducer.

3. An apparatus as claimed in claim 1, wherein the capacitor comprises a dielectric comprising a piezoelectric material.

4. An apparatus as claimed in claim 1, wherein the transducer and the capacitor device are disposed over a common substrate.

5. An apparatus as claimed in claim 4, wherein: the transducer comprises a piezoelectric transducer comprising upper and lower electrodes; and the capacitor device comprises upper and lower electrodes.

6. An apparatus as claimed in claim 5, wherein the upper electrode of the transducer and the upper electrode of the capacitor device are substantially concentric over a portion of an arc length.

7. An apparatus as claimed in claim 6, wherein the lower electrode of the transducer and the lower electrode of the capacitor are substantially concentric over a portion of the arc length.

8. An apparatus as claimed in claim 1, wherein a first noise signal traversing from the first output is substantially identical to a second noise signal traversing from the second output and at an output of the amplifier, the noise signals are cancelled.

9. An apparatus as claimed in claim 8, wherein the first noise signal and the second noise signal are of substantially the same amplitude and phase.

10. An apparatus as claimed in claim 1, wherein the transducer is configured to provide a signal from the first output to the first input and the differential amplifier is configured to amplify the signal.

11. An apparatus configured to transmit acoustic signals or receive acoustic signals, or both, comprising:
a first transducer providing a first output;
a second transducer providing a second output;
a first load impedance connected to the first output;
a second load impedance connected to the second output; and
a differential amplifier having a first input connected to the first output and a second input connected to the second output, wherein the first load impedance is connected electrically in parallel with the first input and the second load impedance is connected electrically in parallel with the second input.

12. An apparatus as claimed in claim 11, wherein the transducers comprise piezoelectric transducers.

13. An apparatus as claimed in claim 11, wherein a first noise signal traversing from the first output is substantially identical to a second noise signal traversing from the second output and at an output of the amplifier, the noise signals cancel.

14. An apparatus as claimed in claim 11, wherein the first and second transducers are configured to provide signals that are approximately π radians out of phase second at the first and second outputs.

15. An apparatus as claimed in claim 11, wherein the transducers are disposed over a common substrate.

16. An apparatus as claimed in claim 11, wherein the upper electrode of the transducers are substantially concentric over a portion of an arc length.

17. An apparatus as claimed in claim 15, wherein the lower electrode of the transducers are substantially concentric over a portion of the arc length.
